(19) United States
(12) Patent Application Publication
(10) Pub. No.: US 2012/0014352 A1
(43) Pub. Date: Jan. 19, 2012

(54) APPARATUS AND METHOD FOR ENFORCEMENT OF MULTIPLE PACKET DATA NETWORK (PDN) CONNECTIONS TO THE SAME ACCESS POINT NAME (APN)

(75) Inventor: Gerardo Giaretta, San Diego, CA (US)

(73) Assignee: QUALCOMM Incorporated, San Diego, CA (US)

(21) Appl. No.: 13/181,250

(22) Filed: Jul. 12, 2011

Related U.S. Application Data
(60) Provisional application No. 61/363,939, filed on Jul. 13, 2010.

(51) Int. Cl. H04W 76/00; H04W 36/08

(52) U.S. Cl. 370/331; 370/328

(57) ABSTRACT

An apparatus and method for enforcement of multiple packet data network (PDN) connections to a same access point name (APN) in a wireless communication system including receiving a message from a mobile device related to a first packet data network (PDN) connection to a first APN; and associating the first PDN connection related to the mobile device with a radio connection between the mobile device and an access point in response to the message. In one example, the apparatus and method further includes determining if the mobile device utilizes at least one additional radio connection with the access point to communicate over at least one additional PDN connection to the first APN.

### CLAIM OF PRIORITY UNDER 35 U.S.C. §119

The present Application for Patent claims priority to Provisional Application No. 61/363,939 entitled Apparatus and Method for Enforcement of Multiple PDN Connections to the Same APN filed Jul. 13, 2010, and assigned to the assignee hereof and hereby expressly incorporated by reference herein.

### FIELD

This disclosure relates generally to apparatus and methods for wireless communication. More particularly, the disclosure relates to enforcement of multiple packet data network (PDN) connections to the same access point name (APN) in a wireless communication system.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Tenn Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{Nₜ, N_{R}}. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

In 3GPP, for example, wireless terminals can connect to base stations to access multiple packet data networks (PDN). In this example, the base stations can communicate with a PDN gateway (e.g., through one or more serving gateways or otherwise) to facilitate accessing the PDNs. In one example, wireless terminals can connect to the multiple PDNs using one or more access point names (APN), where a given APN can relate to a base station or a portion thereof.

In one aspect, an APN is a configurable network identifier used by a mobile device (a.k.a., user equipment (UE)) to access a network service. The 3GPP standards specify that a UE may use multiple PDN connections to different APNs via different radio accesses. For the case of the same APN, 3GPP standards require that multiple PDN connections to the same APN use the same radio access. However, there is no explicit mechanism for enforcing this restriction of the same radio access for the same APN.

### SUMMARY

Disclosed is an apparatus and method for enforcement of multiple packet data network (PDN) connections to the same access point name (APN). According to one aspect, a method for enforcement of multiple packet data network (PDN) connections to a same access point name (APN) in a wireless communication system including receiving a message from a mobile device related to a first packet data network (PDN) connection to a first APN; and associating the first PDN connection related to the mobile device with a radio connection between the mobile device and an access point in response to the message. In one example, the method further includes determining if the mobile device utilizes at least one additional radio connection with the access point to communicate over at least one additional PDN connection to the first APN and revoking the at least one additional PDN connection based at least in part on determining that the mobile device utilizes the at least one additional radio connection, or revoking the at least one additional PDN connection by transmitting a revocation message to the mobile device to close the at least one additional PDN connection.

According to another aspect, an apparatus for enforcement of multiple packet data network (PDN) connections to a same access point name (APN) in a wireless communication system, the apparatus comprising a processor and a memory, the memory containing program code executable by the processor for performing the following: receiving a message from a mobile device related to a first packet data network (PDN) connection to a first APN; and associating the first PDN connection related to the mobile device with a radio connection between the mobile device and an access point in response to the message. In one example, the memory also contains program code for determining if the mobile device utilizes at least one additional radio connection with the access point to communicate over at least one additional PDN connection to the first APN and for revoking the at least one additional PDN connection based at least in part on determining that the mobile device utilizes the at least one additional radio connection, or revoking the at least one additional PDN connection includes transmitting a revocation message to the mobile device to close the at least one additional PDN connection.

According to another aspect, an apparatus for enforcement of multiple packet data network (PDN) connections to a same access point name (APN) in a wireless communication system including means for receiving a message from a mobile device related to a first packet data network (PDN) connection to a first APN; and means for associating the first PDN connection related to the mobile device with a radio connection between the mobile device and an access point in response to the message. In one example, the apparatus also includes means for determining if the mobile device utilizes at least one additional radio connection with the access point to communicate over at least one additional PDN connection to the first APN and means for revoking the at least one additional PDN connection based at least in part on determining that the mobile device utilizes the at least one additional radio connection, or revoking the at least one additional PDN connection by transmitting a revocation message to the mobile device to close the at least one additional PDN connection.

According to another aspect, a computer program product comprising a computer-readable medium having codes for causing a computer to receive a message from a mobile device related to a first packet data network (PDN) connection to a first APN; and associate the first PDN connection related to the mobile device with a radio connection between the mobile device and an access point in response to the message. In one example, the computer program product also include codes to determine if the mobile device utilizes at least one additional radio connection with the access point to communicate over at least one additional PDN connection to the first APN and to revoke the at least one additional PDN connection based at least in part on determining that the mobile device utilizes the at least one additional radio connection, or revoking the at least one additional PDN connection by transmitting a revocation message to the mobile device to close the at least one additional PDN connection.

A potential advantage of the present disclosure may include ensuring that a same radio access is used for the same access point name (APN).

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a wireless communication system for communicating multiple packet data networks (PDNs) over one or more access point names (APNs).

FIG. 2 illustrates an example of a wireless communication system for enforcing a single radio connection for multiple packet data networks (PDNs) related to a given access point name (APN).

FIG. 3a illustrates an example of a first flow diagram for enforcement of multiple packet data network (PDN) connections to a same access point name (APN).

FIG. 3b illustrates an example of a second flow diagram for enforcement of multiple packet data network (PDN) connections to a same access point name (APN).

FIG. 4 illustrates an example of a first device for enforcement of multiple packet data network (PDN) connections to a same access point name (APN).

FIG. 5a illustrates an example of a second device for enforcement of multiple packet data network (PDN) connections to a same access point name (APN).

FIG. 5b illustrates an example of a third device for enforcement of multiple packet data network (PDN) connections to a same access point name (APN).

FIG. 6 illustrates an example of a device including a processor in communication with a memory for executing the processes for enforcement of multiple packet data network (PDN) connections to a same access point name (APN).

FIG. 7 illustrates an example of a multiple access wireless communication system in accordance with the present disclosure.

FIG. 8 illustrates an example of a block diagram of a transmitter system and a receiver system 250 in a multiple-input-multiple-output (MIMO) system.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Tenn Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE or LTE-A, and LTE or LTE-A terminology may be used the description without intention of limiting the scope or spirit of the present disclosure to only LTE or LTE-A systems.

Logical channels may be classified into Control Channels and Traffic Channels. Logical Control Channels may include Broadcast Control Channel (BCCH) which is DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing RRC connection this channel is only used by mobile device (a.k.a., user equipment (UE) or wireless device) that receives MBMS. Dedicated Control Channel (DCCH) is a point-to-point bi-directional channel that transmits dedicated control information and is used by the mobile device having an RRC connection. Logical Traffic Channels may include a Dedicated Traffic Channel (DTCH) which is a point-to-point bi-directional channel, dedicated to one mobile device, for the transfer of user information. Also, a Multicast Traffic Channel (MTCH) may be used for point-to-multipoint DL channel for transmitting traffic data.

Transport Channels are classified into downlink (DL) and uplink (UL). DL Transport Channels includes a Broadcast Channel (BCH), Downlink Shared Data Channel (DL-SDCH) and a Paging Channel (PCH). The PCH for support of UE power saving (DRX cycle is indicated by the network to the mobile device), is broadcasted over entire cell and mapped to PHY resources which may be used for other control/traffic channels. The UL Transport Channels includes a Random Access Channel (RACH), a Request Channel (REQCH), a Uplink Shared Data Channel (UL-SDCH) and plurality of PHY channels. The PHY channels include a set of DL channels and UL channels.

In one aspect, the DL PHY channels may include one or more of the following:
Common Pilot Channel (CPICH)
Synchronization Channel (SCH)
Common Control Channel (CCCH)
Shared DL Control Channel (SDCCH)
Multicast Control Channel (MCCH)
Shared UL Assignment Channel (SUACH)
Acknowledgement Channel (ACKCH)
DL Physical Shared Data Channel (DL-PSDCH)
UL Power Control Channel (UPCCH)
Paging Indicator Channel (PICH)
Load Indicator Channel (LICH)

In one aspect, the UL PHY channels may include one or more of the following:
Physical Random Access Channel (PRACH)
Channel Quality Indicator Channel (CQICH)
Acknowledgement Channel (ACKCH)
Antenna Subset Indicator Channel (ASICH)
Shared Request Channel (SREQCH)
UL Physical Shared Data Channel (UL-PSDCH)
Broadband Pilot Channel (BPICH)

In an aspect, a channel structure is provided that preserves low peak to average ratio (PAR) properties of a single carrier waveform, and at any given time, the channel is contiguous or uniformly spaced in frequency. For the purposes of the present disclosure, one or more of the following abbreviations may apply:
AM Acknowledged Mode
AMD Acknowledged Mode Data
APN Access Point Name
ARQ Automatic Repeat Request
BCCH Broadcast Control CHannel
BCH Broadcast CHannel
C- Control-
CCCH Common Control CHannel
CCH Control CHannel
CCTrCH Coded Composite Transport Channel
CoA Care-of Address
CP Cyclic Prefix
CRC Cyclic Redundancy Check
CTCH Common Traffic CHannel
DCCH Dedicated Control CHannel
DCH Dedicated CHannel
DL DownLink
DSCH Downlink Shared CHannel
DSMIP Dual Stack Mobile IP
DTCH Dedicated Traffic CHannel
FACH Forward link Access CHannel
FDD Frequency Division Duplex
GPRS General Packet Radio Service
GTP GPRS Tunnelling Protocol
GW Gateway
IP Internet Protocol
L1 Layer 1 (physical layer)
L2 Layer 2 (data link layer)
L3 Layer 3 (network layer)
L1 Length Indicator
LSB Least Significant Bit
MAC Medium Access Control
MBMS Multimedia Broadcast Multicast Service
MCCHMBMS point-to-multipoint Control CHannel
MRW Move Receiving Window
MSB Most Significant Bit
MSCH MBMS point-to-multipoint Scheduling CHannel
MTCHMBMS point-to-multipoint Traffic CHannel
PCCH Paging Control CHannel
PCH Paging CHannel
PDU Protocol Data Unit
PDN Packet Data Network
PHY PHYsical layer
PhyCHPhysical Channels
PMIP Proxy Mobile IP
RACH Random Access CHannel
RLC Radio Link Control
RRC Radio Resource Control
SAP Service Access Point
SDU Service Data Unit
SGW Serving Gateway
SHCCH SHared channel Control CHannel
SN Sequence Number
SUFI SUper FIeld
TCH Traffic CHannel
TDD Time Division Duplex
TFI Transport Format Indicator
TM Transparent Mode
TMD Transparent Mode Data
TTI Transmission Time Interval
U- User-
UE User Equipment
UL UpLink
UM Unacknowledged Mode
UMD Unacknowledged Mode Data
UMTS Universal Mobile Telecommunications System
UTRA UMTS Terrestrial Radio Access
UTRAN UMTS Terrestrial Radio Access Network
MBSFN multicast broadcast single frequency network
MCE MBMS coordinating entity
MCH multicast channel
DL-SCH downlink shared channel
MSCH MBMS control channel
PDCCH physical downlink control channel
PDSCH physical downlink shared channel

One or more wireless network components may utilize PDN connections to a single access point name (APN) over a single radio connection or radio access. In one aspect, an APN is a configurable network identifier used by a mobile device (a.k.a., user equipment (UE)) to connect to an external network, for example, the Internet. In another aspect a radio connection or radio access is a particular wireless technology used to connect a mobile device to a wireless network. In one example, addresses utilized by a mobile device connected to the PDNs using the APN may be verified to determine whether the same address is used for each connection. If not, the PDN connections using different radio connections may be revoked. In an example, addresses may be verified upon handing over mobile device communications to a disparate access point.

The 3GPP standard has specified that a mobile device (a.k.a., UE) may use multiple PDN connections to different APNs via different radio accesses. However, there is a restriction that multiple PDN connections to the same APN cannot be routed to two different radio accesses. Moreover, the 3GPP standard does not define the mechanisms for a wireless network to enforce that all PDN connections to the same APN are routed through the same radio access.

As one example implementation for enforcing a single radio connection for multiple PDN connections with a single APN, the same PDN gateway (GW) may be allocated to multiple PDN connections to the same APN. When the PDN GW receives a handover message to move one PDN connection to a target radio access, it may initialize a timer Ti. In one example, when the timer T1 expires or at some other point time, the PDN GW may check if other PDN connections to the same APN are in a different radio access. For example, the check may be based on IP addresses (e.g., care of addresses, CoAs) registered for each PDN. If there are one or more PDN connections in a different radio access, the PDN GW may send a revocation message to the UE to close those PDN connections.

In one example, generic tunneling protocol (GTP) may be used for 3GPP, e.g., LTE, access and dual stack mobile Internet protocol version 6 (DSMIPv6) may be used for non-3GPP access. In one aspect, a handover message may be a DSMIPv6 Binding Update message with a new CoA or without a CoA (de-registration). In another aspect, the PDN GW compares if PDN connections are from the same radio access by checking if the same CoA or no CoA is registered. If there is a mismatch then the PDN GW sends a Binding Revocation Indication message for all PDN connections which are still in the old access or it terminates the PDN connections in the 3GPP access.

In another example, generic tunneling protocol (GTP) may be used for 3GPP access, e.g., LTE, and proxy mobile Internet protocol version 6 (PMIPv6) may be used for non-3GPP access. In one aspect, a handover message may be a PMIPv6 Proxy Binding Update message with a new CoA or a GTP Bearer Establishment message over LTE with a handover indication. In another aspect, the PDN GW compares if PDN connections are from the same radio access by checking if for all PDN connections to the same APN, the same CoA or no CoA is registered. If there is a mismatch then the PDN GW sends a Binding Revocation Indication message for all PDN connections which are still in the old access or it terminates the PDN connections in the 3GPP access.

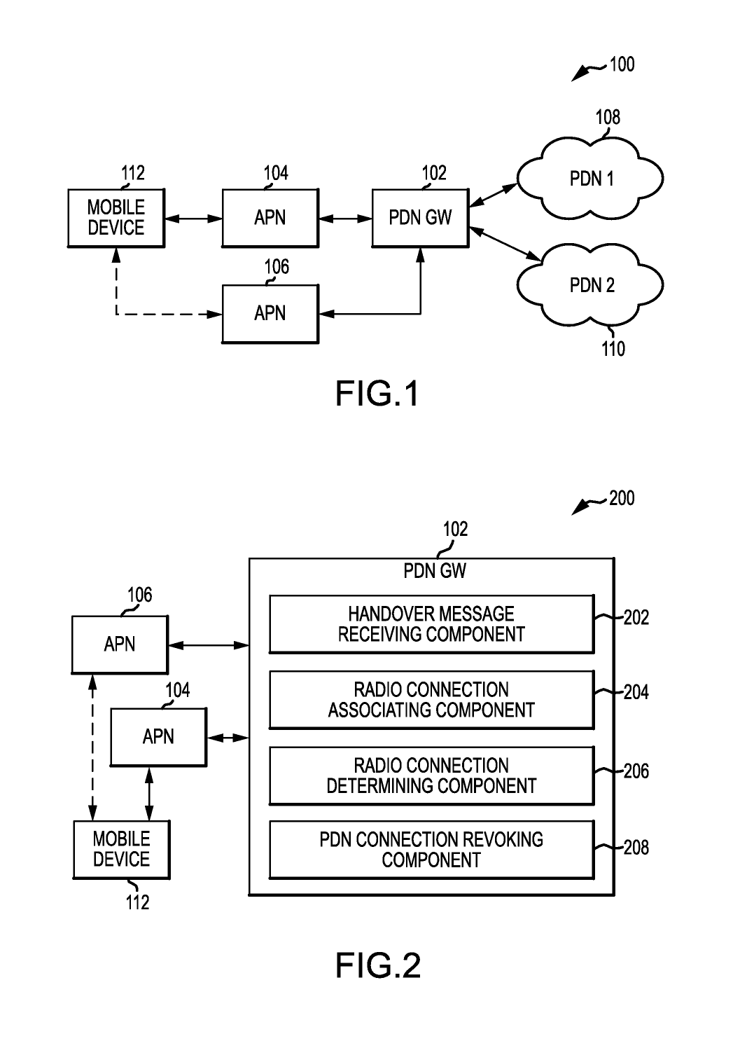

FIG. 1 illustrates an example of a wireless communication system 100 for communicating multiple packet data networks (PDNs) over one or more access point names (APNs). As illustrated in the example in FIG. 1, the wireless communication system 100 includes a PDN gateway (GW) 102 that provides APN 104 and APN 106 access to PDN 1 108 and PDN 2 110 (or additional PDNs) for a mobile device 112 (a.k.a., UE). For example, the APN 104 and the APN 106 may relate to access points that provide one or more mobile devices with connections to one or more wireless networks. Thus, as shown, the APN 104 may provide the mobile device 112 with access to the PDN 1 108 and/or the PDN 2 110 through the PDN GW 102. The APN 104 and the APN 106, and/or related access points, may be macrocell access points, femtocell access points, picocell access points, mobile base stations, relay nodes, etc. Although a list of APNs is provided herein, one skilled in the art would understand that the list is only an example and does not exclude other examples.

Moreover, it is to be appreciated that one or more serving gateways (SGWs) (not shown) may facilitate communications between the APN 104 (and/or the APN 106) and the PDN GW 102. In addition, the PDN 1 108 and the PDN 2 110 may be substantially any 3GPP or non-3GPP PDN to which the PDN GW 102 may provide access (e.g., LTE, IP, etc.).

According to an example, the mobile device 112 may connect to the PDN 1 108 and the PDN 2 110 using the APN 104 and/or the APN 106. For example, the mobile device 112 accesses both the PDN 1 108 and the PDN 2 110 via the APN 104. The mobile device 112 may connect to the APN 104 over one or more radio connections. For each radio connection, the PDN GW 102 may assign an address to the mobile device 112 (e.g., an IP or similar address) for identifying communications between the PDN GW 102 and the mobile device 112 through the respective radio connection to the APN 104. The wireless communication system 100 may facilitate enforcing that connections from the mobile device 112 to multiple PDNs through a single APN using a single radio connection between the mobile device 112 and the single APN (e.g., to comply with a 3GPP or other network specification, or otherwise).

Thus, in one example, a single radio connection for multiple PDN connections using the single APN may be enforced at least upon handing over the mobile device 112 communications among access points and/or related APNs. For example, the PDN GW 102 receives a message to handover at least one PDN connection of the mobile device 112 to a target access point or related APN, such as APN 106. Based at least in part on receiving the message, the PDN GW 102 determines whether the mobile device 112 connects to the APN 106 to receive access to at least one disparate PDN using at least one disparate radio connection. The determination may occur, for instance, following handover (e.g., according to a timer initialized upon receiving the message), or during handover, or before handover based on one or more events. For example, the PDN GW 102 may determine addresses for PDN connections of the mobile device 112 at the APN 106. The addresses may relate to a care of address (CoA) or other addresses assigned by the PDN GW 102 for the radio connection(s) between the mobile device 112 and the APN 106. In one example, the care of address (CoA) is a temporary IP address of the mobile device 112 when it is away from its home network.

In one example, where the PDN GW 102 determines that the mobile device 112 connects to the APN 106 over at least one disparate radio connection, the PDN GW 102 terminates the PDN connection over the at least one disparate radio connection. For example, the PDN GW 102 transmits a revocation message to the mobile device 112 through the APN 106 to close PDN connections over the at least one disparate radio connection. Thus, for example, the PDN GW 102 determines one or more addresses related to the PDN connections at the mobile device 112 with the APN 106 that differ from the address of the PDN connection for which the handover message is received at the APN 106, and the PDN GW 102 closes any such PDN connections having differing addresses to enforce a single radio connection for the multiple PDN connections at a single APN.

FIG. 2 illustrates an example of a wireless communication system 200 for enforcing a single radio connection for multiple packet data networks (PDNs) related to a given access point name (APN) based at least in part on performing a handover. As illustrated in FIG. 2, the example wireless communication system 200 includes a PDN GW 102 that provides the APN 104 and the APN 106 with access to one or more PDNs (not shown). The APN 104 and APN 106 may, in turn, provide access to the one or more PDNs to the mobile device 112 through the PDN GW 102 (and/or one or more SGWs). In addition, the PDN GW 102 may assign addresses to the mobile device 112 for radio connections with the APN 104, 106 or other APNs connected to the PDN GW 102 to identify communications related to given radio connections.

In one aspect, the PDN GW 102 includes a handover message receiving component 202 that obtains a message related to handing over mobile device communications from a source APN (or related access point) to a target APN (or related access point). The PDN GW 102 may also include a radio connection associating component 204 that correlates one or more PDN connections of the mobile device 112 with a radio connection (i.e. radio access) related to the target APN. The PDN GW 102 may additionally include a radio connection determining component 206 that identifies whether one or more disparate radio connections exist between the mobile device and the target APN following handover. And the PDN GW 102 may include a PDN connection revoking component 208 that causes termination of one or more radio connections between the mobile device and the target APN.

According to one example, the mobile device 112 communicates with the APN 104 over a radio connection (i.e. radio access) to access one or more PDNs. In addition, the mobile device 112 communicates with one or more disparate APNs to additionally or alternatively receive access to disparate PDNs. The APN 104, or the related access point, determines to handover the mobile device 112 communications for at least one PDN connection to the APN 106, or the related access point. For example, the APN 104 may determine such based at least in part on measurement reports received from the mobile device 112 regarding neighboring APNs or related access points. As part of the handover, for example, the APN 104 transmits a handover message to the PDN GW 102 that indicates handover of at least one PDN connection related to the mobile device 112 from the APN 104 to the APN 106. The handover message receiving component 202 obtains the handover message from the APN 104, in this example.

In one example, the PDN GW 102 additionally facilitates handing over the PDN connection related to the mobile device 112 to the APN 106. For example, the PDN GW 102 assigns a new address for a radio connection between the mobile device 112 and the APN 106 established during the handover and associates a context or other information related to the previous connection between the mobile device 112 and the APN 104 with the new address. In one example, the radio connection associating component 204 associates the radio connection, new address, context information, etc., to the PDN connection indicated in the handover message.

In another example, the radio connection the associating component 204 also assigns the address to the radio connection. In one example, the PDN GW 102 may enforce a single radio connection with the APN 106 to access multiple PDNs at the mobile device 112. In this regard, the radio connection determining component 206 determines whether the mobile device 112 connects to the APN 106 using one or more disparate radio connections different than the radio connection correlated to the PDN connection by the radio connection associating component 204. For example, the radio connection determining component 206 determines an address assigned to the radio connection between the mobile device 112 and the APN 106 established during handover and determines whether other PDN connections exist for the mobile device 112 through the APN 106. If the radio connection determining component 206 locates additional PDN connections between the mobile device 112 and the APN 106, it determines whether the additional PDN connections correspond to a disparate address than the radio connection established during handover.

In one aspect, where the radio connection determining component 206 locates such additional PDN connections that correspond to the different radio connections (e.g., based on address), the PDN connection revoking component 208 causes termination of the PDN connections that correspond to the different radio connections. For example, the PDN connection revoking component 208 transmits a revocation message to the mobile device 112 (e.g., via APN 106) related to the PDN connection to terminate the PDN connection. In this example, a single radio connection for multiple PDN connections at an APN is enforced. In addition, for example, the radio connection determining component 206 determines whether additional PDN connections exist between the mobile device 112 and the APN 106 based at least in part on a timer or other event following receiving the handover message. For example, when the handover message receiving component 202 obtains the handover message, the radio connection determining component 206 initializes the timer. For example, the timer is initialized to a value that allows for completion of the handover (e.g., based on previous metrics related to the handover, for example, at a configured value).

Upon expiration of the timer, the radio connection determining component 206 determines whether additional PDN connections exist between the mobile device 112 and the APN 106. In one example, the radio connection determining component 206 determines such based at least in part on an event, such as receiving another message or notification during handover.

According to one example, the mobile device 112 establishes a connection to the APN 104 to receive access to a 3GPP and a non-3GPP PDN. In this regard, the PDN GW 102 may further provide the APN 104 with access to the 3GPP and non-3GPP PDN. In one example, the 3GPP PDN relates to LTE that uses GPRS tunneling protocol (GTP) for communicating between the PDN GW 102 and the mobile device 112. And, in one example, the non-3GPP PDN is an IP network that utilizes dual stack mobile Internet protocol version 6 (DSMIPv6) to communicate between the PDN GW 102 and the mobile device 112. The APN 104 may initiate handing over a PDN connection related to the mobile device 112 to the APN 106. In this example, the handover message receiving component 202 obtains a DSMIPv6 Binding Update from the APN 104 and/or the APN 106, which may include a new address (e.g., a CoA) or no address to indicate de-registration.

The Radio connection associating component 204 may correlate the new address or no address, and thus a corresponding radio connection between the mobile device 112 and the APN 106, to the non-3GPP connection related to the mobile device 112. In one example, the radio connection determining component 206 initializes a timer. The timer value may allow the APN 104 to also handover the 3GPP connection to the APN 106 before time expiration. Upon receiving the DSMIPv6 Binding Update or upon expiration of the timer, the radio connection determining component 206 determines whether additional PDN connections exist between the mobile device 112 and the APN 106.

In one example, the radio connection determining component 206 identifies the 3GPP connection between the mobile device 112 and the APN 106. In this example, the radio connection determining component 206 determines whether the address (e.g., CoA) or lack thereof related to the 3GPP connection matches that associated to the non-3GPP connection by the radio connection associating component 204. If it does not, there are multiple radio connections between the mobile device 112 and the APN 106 for the different PDNs, and the PDN connection revoking component 208 transmits a Binding Revocation Indication for the 3GPP connection (and any other connections that have a disparate address) to the mobile device 112 to facilitate terminating the connections. It is to be appreciated that the PDN connection revoking component 208 may additionally or alternatively terminate the PDN connections related to the mobile device 112 that utilize a disparate address.

In another example, the 3GPP PDN relates to LTE that uses GTP for communicating between the PDN GW 102 and the mobile device 112, and the non-3GPP PDN is an IP network that utilizes proxy mobile Internet protocol version 6 (PMIPv6) to communicate between the PDN GW 102 and the mobile device 112. The APN 104 initiates handing over the mobile device 112 communication to the APN 106. In this example, the handover message receiving component 202 obtains a PMIPv6 Binding Update from the APN 104 and/or the APN 106 which may include a new address (e.g., a CoA) or a GTP Bearer Establishment over LTE with handover indication. The radio connection associating component 204 correlates the new address, and thus a corresponding radio connection between the mobile device 112 and the APN 106, to one of the PDN connections related to the mobile device 112. In one example, the radio connection determining component 206 initializes a timer. Upon receiving the PMIPv6 Binding Update or GTP Bearer Establishment with handover indication, upon expiration of the timer, the radio connection determining component 206 determines whether additional PDN connections exist between the mobile device 112 and the APN 106. If so, the radio connection determining component 206 determines whether the address (e.g., CoA) related to the additional PDN connection matches that of the new address received in the PMIPv6 Binding Update or GTP Bearer Establishment with handover indication and associated to the radio connection by the radio connection associating component 204. If it does not, there are multiple radio connections between the mobile device 112 and the APN 106 for the different PDNs, and the PDN connection revoking component 208 transmits a Binding Revocation Indication for the connection(s) that utilize a disparate address to facilitate terminating the connections. It is to be appreciated that the PDN connection revoking component 208 may additionally or alternatively terminate the PDN connections related to the mobile device 112 that utilize a disparate address.

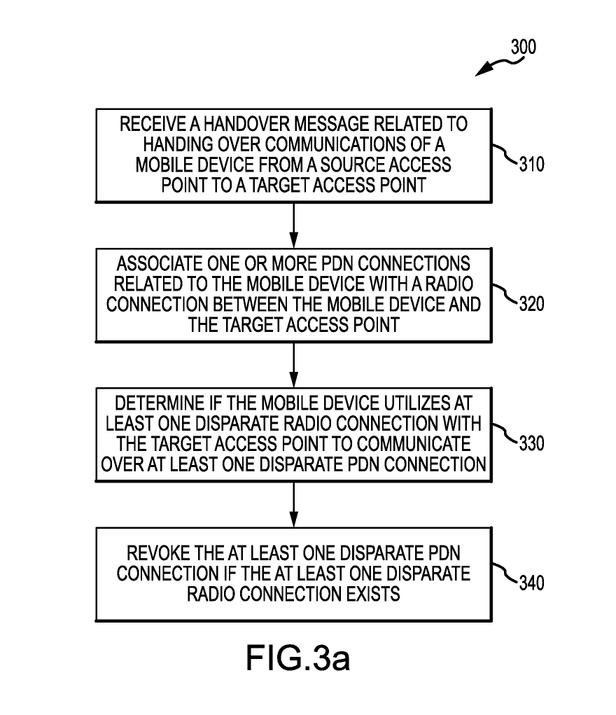

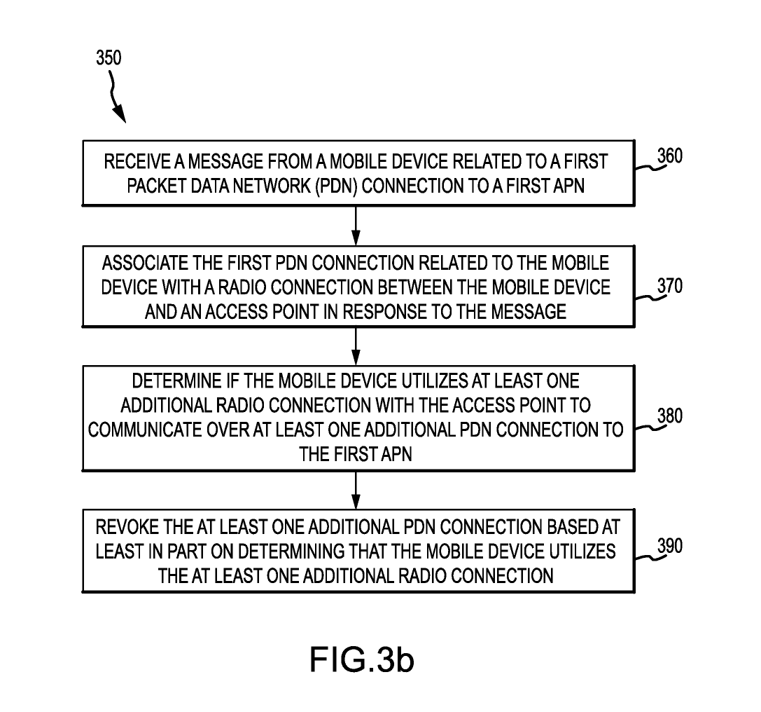

FIG. 3a illustrates an example of a first flow diagram 300 for enforcement of multiple packet data network (PDN) connections to a same access point name (APN). In block 310, receive a handover message related to handing over communications of a mobile device from a source access point to a target access point. For example, the handover message may include an indication of a packet data network (PDN) connection of the mobile device to be handed over.

In block 320, associate one or more packet data network (PDN) connections related to the mobile device with a radio connection between the mobile device and the target access point in response to the handover message. In one example, the radio connection is a PDN connection specified in the handover message and is associated from a radio connection with the serving access point to another radio connection with the target access point which is established during handing over. In one example, the associating step includes receiving an address corresponding to the radio connection and associating the one or more PDN connections to the address.

In block 330, determine if the mobile device utilizes at least one disparate radio connection with the target access point to communicate over at least one disparate PDN connection. In one example, this can be determined based at least in part on comparing an address of the radio connection associated to the one or more PDN connections with an address of the disparate radio connection associated with the at least one disparate PDN connection. And, in another example, the determining step includes determining whether a disparate address related to the at least one disparate radio connection differs from the address corresponding to the radio connection.

In block 340, revoke the at least one disparate PDN connection if the at least one disparate radio connection exists. In one example, the revoking step includes transmitting a revocation message to the mobile device to close the at least one disparate PDN connection. In one example, the revocation message is a binding revocation indication message of a PMIPv6 Proxy Binding Update message. In one aspect, the steps of the first flow diagram of FIG. 3a further include initializing a timer upon receiving the handover message. And, in one example, the determining step is performed following expiration of the timer.

FIG. 3b illustrates an example of a second flow diagram 350 for enforcement of multiple packet data network (PDN) connections to a same access point name (APN). In block 360, receive a message from a mobile device related to a first packet data network (PDN) connection to a first APN. In block 370, associate the first PDN connection related to the mobile device with a radio connection between the mobile device and an access point in response to the message. In one aspect, the second flow diagram 350 also includes blocks 380 and/or 390. In block 380, determine if the mobile device utilizes at least one additional radio connection with the access point to communicate over at least one additional PDN connection to the first APN. In block 390, revoke the at least one additional PDN connection based at least in part on determining that the mobile device utilizes the at least one additional radio connection.

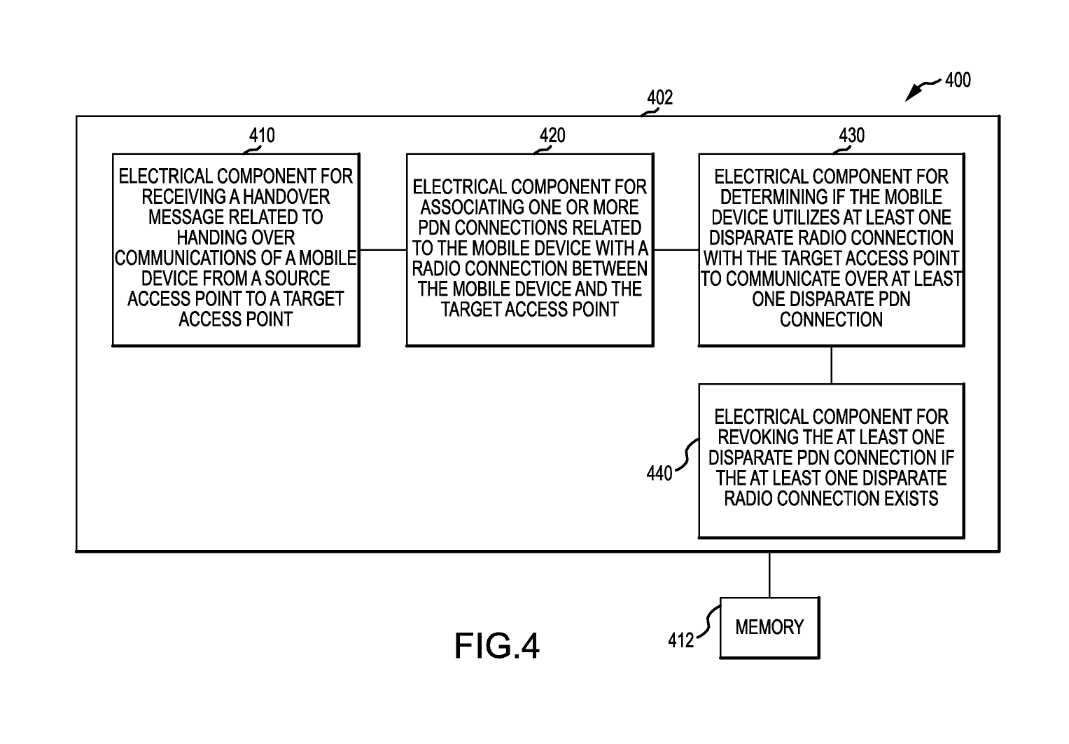

FIG. 4 illustrates an example of a first device 400 for enforcement of multiple packet data network (PDN) connections to a same access point name (APN). The device 400 may be configured as a communication device or as a processor or similar device for use within the communication device. As depicted, device 400 may include functional blocks that can represent functions implemented by a processor, software, hardware or combination thereof (e.g., firmware).

As illustrated, device 400 may include an electrical component 410 for receiving a handover message related to handing over communications of a mobile device from a source access point to a target access point. The device 400 may include an electrical component 420 for associating one or more packet data network (PDN) connections related to the mobile device with a radio connection between the mobile device and the target access point in response to the handover message. The device 400 may include an electrical component 430 for determining if the mobile device utilizes at least one disparate radio connection with the target access point to communicate over at least one disparate PDN connection. The device 400 may include an electrical component 440 for revoking the at least one disparate PDN connection if the at least one disparate radio connection exists. In one aspect, the electrical components 410-440 may perform the functions depicted in the second flow diagram of FIG. 3b, wherein electrical component 410 corresponds to block 360, electrical component 420 corresponds to block 370, electrical component 430 corresponds to block 380, and electrical component 440 corresponds to block 390.

Device 400 may optionally include a processor module 402 having at least one processor. In one aspect, device 400 may be configured as a communication network entity, rather than as a processor. Processor 402, in such case, may be in operative communication with electrical components 410-440 via a bus (not shown) or a similar communication coupling. Processor 402 may effect initiation and scheduling of the processes or functions performed by electrical components 410-440.

In related aspects, device 400 may include a transceiver module (not shown). A stand-alone receiver and/or stand-alone transmitter may be used in lieu of or in conjunction with transceiver module. In further related aspects, device 400 may optionally include a module for storing information, such as, for example, a memory module 412. The memory module 412 may include a computer readable medium and may be operatively coupled to the other components of device 400 via a bus (not shown) or the like. The memory module 412 may be adapted to store computer readable codes, instructions and/or data for effecting the processes and behavior of electrical components 410-440, and subcomponents thereof, or processor 402, or the methods disclosed herein. Memory module 412 may retain codes/instructions for executing functions associated with electrical components 410-440. While shown as being external to memory module 412, it is to be understood that electrical components 410-440 may exist within memory module 412.

One skilled in the art would understand that the steps disclosed in the example flow diagrams in FIGS. 3a and 3b may be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art. In one aspect, the computer-readable medium includes non-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

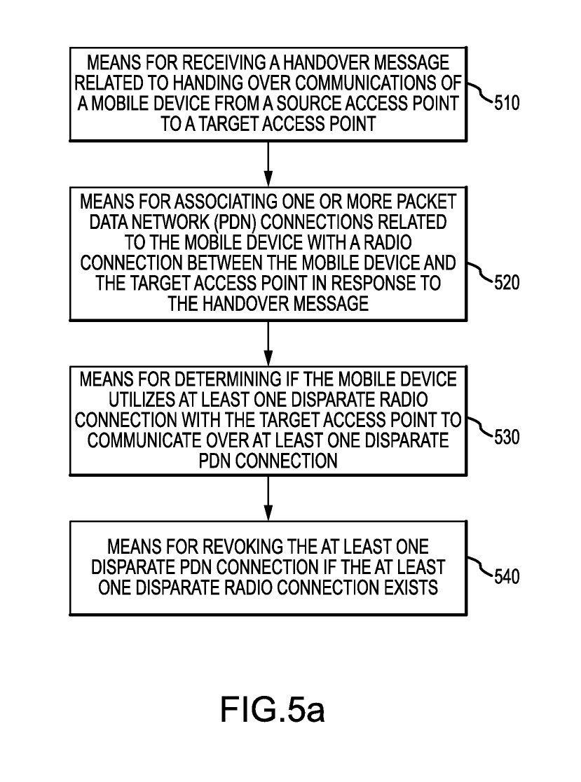

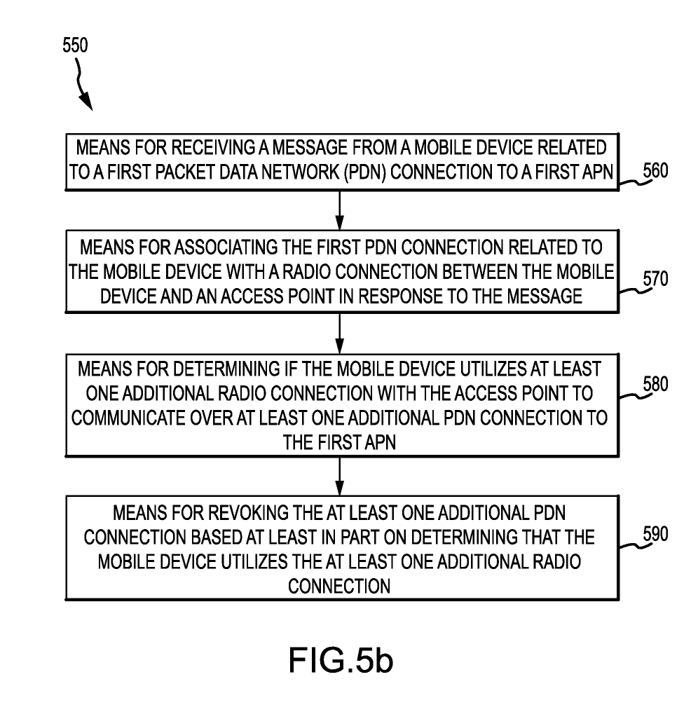

FIG. 5a illustrates an example of a second device 500 for enforcement of multiple packet data network (PDN) connections to a same access point name (APN). In one aspect, the second device 500 is implemented by at least one processor including one or more modules configured to provide different aspects of enforcement of multiple packet data network (PDN) connections to a same access point name (APN) as described herein in blocks 510, 520, 530 and 540. For example, each module includes hardware, firmware, software, or any combination thereof. In one aspect, the second device 500 is also implemented by at least one memory in communication with the at least one processor.

FIG. 5b illustrates an example of a third device 550 for enforcement of multiple packet data network (PDN) connections to a same access point name (APN). In one aspect, the third device 550 is implemented by at least one processor including one or more modules configured to provide different aspects of enforcement of multiple packet data network (PDN) connections to a same access point name (APN) as described herein in blocks 560, 570, 580 and 590. For example, each module includes hardware, firmware, software, or any combination thereof. In one aspect, the third device 550 is also implemented by at least one memory in communication with the at least one processor.

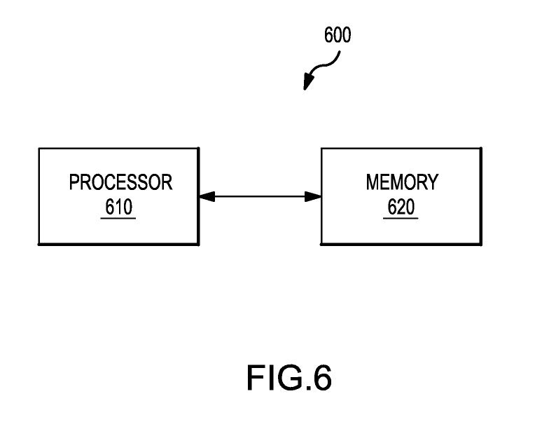

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 6 illustrates an example of a device 600 including a processor 610 in communication with a memory 620 for executing the processes for enforcement of multiple packet data network (PDN) connections to a same access point name (APN). In one example, the device 600 is used to implement the algorithms illustrated in FIGS. 3a and 3b. In one aspect, the memory 620 is located within the processor 610. In another aspect, the memory 620 is external to the processor 610. In one aspect, the processor includes circuitry for implementing or performing the various flow diagrams, logical blocks and/or modules described herein.

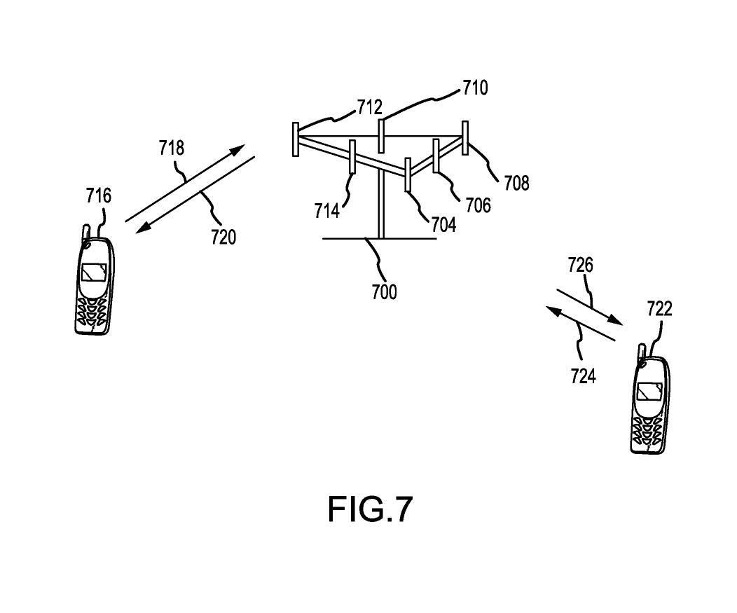

FIG. 7 illustrates an example of a multiple access wireless communication system in accordance with the present disclosure. An access point 700 (AP) includes multiple antenna groups, one including 704 and 706, another including 708 and 710, and an additional including 712 and 714. In one aspect, the access point 700 is associated with the APN 104, 106 illustrated in FIG. 1.

In FIG. 7, only two antennas are shown for each antenna group, however, more or fewer antennas may be utilized for each antenna group. Mobile device 716 is in communication with antennas 712 and 714, where antennas 712 and 714 transmit information to the mobile device 716 over forward link 720 and receive information from the mobile device 716 over reverse link 718. Mobile device 722 is in communication with antennas 706 and 708, where antennas 706 and 708 transmit information to mobile device 722 over forward link 726 and receive information from the mobile device 722 over reverse link 724. In a FDD system, communication links 718, 720, 724 and 726 may use different frequency for communication. For example, forward link 720 may use a different frequency then that used by reverse link 718.

Each group of antennas and/or the area in which they are designed to communicate is often referred to as a sector of the access point. In one aspect, each antenna group is designed to communicate to mobile devices in a sector, of the areas covered by access point 700.

In communication over forward links 720 and 726, the transmitting antennas of access point 700 utilize beamforming in order to improve the signal-to-noise ratio of forward links for the different mobile devices 716 and 722. In one aspect, an access point using beamforming to transmit to access terminals scattered randomly through its coverage causes less interference to access terminals in neighboring cells than an access point transmitting through a single antenna to all its access terminals.

An access point may be a fixed station used for communicating with the mobile devices and may also be referred to as a Node B, an eNodeB or some other terminology. A mobile device may also be called an access terminal, a user equipment (UE), a wireless communication device, a terminal or some other terminology.

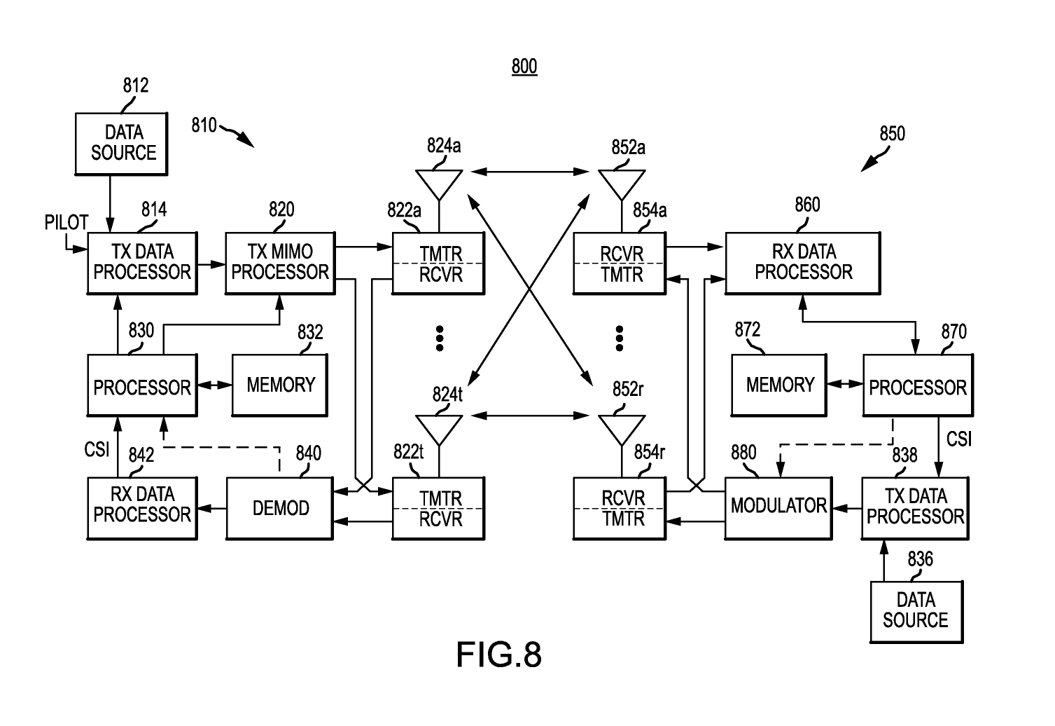

FIG. 8 illustrates an example of a block diagram of a transmitter system 810 (also known as the access point) and a receiver system 850 (also known as a mobile device or access terminal) in a multiple-input-multiple-output (MIMO) system 800. At the transmitter system 810, traffic data for a number of data streams is provided from a data source 812 to a transmit (TX) data processor 814.

In one aspect, each data stream is transmitted over a respective transmit antenna. TX data processor 814 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 830.

The modulation symbols for all data streams are then provided to a TX MIMO processor 820, which may further process the modulation symbols (e.g., for OFDM). TX MIMO processor 820 then provides NT modulation symbol streams to NT transmitters (TMTR) 822a through 822t. In one aspect, the TX MIMO processor 820 applies beamforming weights to the symbols of the data streams and to the antenna from which the symbol is being transmitted.

Each transmitter 822 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 822a through 822t are then transmitted from NT antennas 824a through 824t, respectively.

At receiver system 850, the transmitted modulated signals are received by NR antennas 852a through 852r and the received signal from each antenna 852 is provided to a respective receiver (RCVR) 854a through 854r. Each receiver 854 conditions (e.g., filters, amplifies, and downconverts) a respective received signal, digitizes the conditioned signal to provide samples, and further processes the samples to provide a corresponding “received” symbol stream.

An RX data processor 860 then receives and processes the NR received symbol streams from NR receivers 854 based on a particular receiver processing technique to provide NT “detected” symbol streams. The RX data processor 860 then demodulates, deinterleaves, and decodes each detected symbol stream to recover the traffic data for the data stream. The processing by RX data processor 860 is complementary to that performed by TX MIMO processor 820 and TX data processor 814 at transmitter system 810.

A processor 870 periodically determines which pre-coding matrix to use (discussed below). Processor 870 formulates a reverse link message including a matrix index portion and a rank value portion.

The reverse link message may include various types of information regarding the communication link and/or the received data stream. The reverse link message is then processed by a TX data processor 838, which also receives traffic data for a number of data streams from a data source 836, modulated by a modulator 880, conditioned by transmitters 854a through 854r, and transmitted back to transmitter system 810.

At transmitter system 810, the modulated signals from receiver system 850 are received by antennas 824, conditioned by receivers 822, demodulated by a demodulator 840, and processed by a RX data processor 842 to extract the reserve link message transmitted by the receiver system 850. Processor 830 then determines which pre-coding matrix to use for determining the beamforming weights then processes the extracted message.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for enforcement of multiple packet data network (PDN) connections to a same access point name (APN) in a wireless communication system, the method comprising:
receiving a message from a mobile device related to a first packet data network (PDN) connection to a first APN; and
associating the first PDN connection related to the mobile device with a radio connection between the mobile device and an access point in response to the message.

2. The method of claim 1 further comprising determining if the mobile device utilizes at least one additional radio connection with the access point to communicate over at least one additional PDN connection to the first APN.

3. The method of claim 2, wherein the access point is a target access point.

4. The method of claim 2, wherein the access point is a source access point.

5. The method of claim 2, wherein the message is a handover message relating to handing over the mobile device from a source access point to a target access point.

6. The method of claim 2, further comprising revoking the at least one additional PDN connection based at least in part on determining that the mobile device utilizes the at least one additional radio connection.

7. The method of claim 6, wherein the revoking the at least one additional PDN connection includes transmitting a revocation message to the mobile device to close the at least one additional PDN connection.

8. The method of claim 7, wherein the revocation message is a binding revocation indication message of a PMIPv6 Proxy Binding Update message.

9. The method of claim 2, wherein the associating the first PDN connection includes receiving an address corresponding to the radio connection and associating the first PDN connection to the address.

10. The method of claim 9, wherein the determining comprises determining whether a disparate address related to the at least one additional radio connection differs from the address corresponding to the radio connection.

11. The method of claim 5, further comprising initializing a timer upon receiving the handover message.

12. The method of claim 11, wherein the determining is performed following expiration of the timer.

13. The method of claim 2, wherein the first PDN connection relates to a 3GPP network and the at least one additional PDN connection relates to an IP network.

14. The method of claim 2, wherein the determining is performed based on at least one IP addresses or care of addresses (CoAs).

15. An apparatus for enforcement of multiple packet data network (PDN) connections to a same access point name (APN) in a wireless communication system, the apparatus comprising a processor and a memory, the memory containing program code executable by the processor for performing the following: receiving a message from a mobile device related to a first packet data network (PDN) connection to a first APN; and
associating the first PDN connection related to the mobile device with a radio connection between the mobile device and an access point in response to the message.

16. The apparatus of claim 15, wherein the memory further comprising program code for determining if the mobile device utilizes at least one additional radio connection with the access point to communicate over at least one additional PDN connection to the first APN.

17. The apparatus of claim 16, wherein the access point is a target access point.

18. The apparatus of claim 16, wherein the access point is a source access point.

19. The apparatus of claim 16, wherein the message is a handover message relating to handing over the mobile device from a source access point to a target access point.

20. The apparatus of claim 16, wherein the memory further comprising program code for revoking the at least one additional PDN connection based at least in part on determining that the mobile device utilizes the at least one additional radio connection.

21. The apparatus of claim 20, wherein the memory further comprising program code for transmitting a revocation message to the mobile device to close the at least one additional PDN connection.

22. The apparatus of claim 21, wherein the revocation message is a binding revocation indication message of a PMIPv6 Proxy Binding Update message.

23. The apparatus of claim 16, wherein the memory further comprising program code for receiving an address corresponding to the radio connection and associating the first PDN connection to the address.

24. The apparatus of claim 23, wherein the memory further comprising program code for determining whether a disparate address related to the at least one additional radio connection differs from the address corresponding to the radio connection.

25. The apparatus of claim 19, wherein the memory further comprising program code for initializing a timer upon receiving the handover message.

26. The apparatus of claim 16, wherein the first PDN connection relates to a 3GPP network and the at least one additional PDN connection relates to an IP network.

27. An apparatus for enforcement of multiple packet data network (PDN) connections to a same access point name (APN) in a wireless communication system, the apparatus comprising:
means for receiving a message from a mobile device related to a first packet data network (PDN) connection to a first APN; and
means for associating the first PDN connection related to the mobile device with a radio connection between the mobile device and an access point in response to the message.

28. The apparatus of claim 27 further comprising means for determining if the mobile device utilizes at least one additional radio connection with the access point to communicate over at least one additional PDN connection to the first APN.

29. The apparatus of claim 28, wherein the access point is a target access point.

30. The apparatus of claim 28, wherein the access point is a source access point.

31. The apparatus of claim 28, wherein the message is a handover message relating to handing over the mobile device from a source access point to a target access point.

32. The apparatus of claim 28, further comprising means for revoking the at least one additional PDN connection based at least in part on determining that the mobile device utilizes the at least one additional radio connection.

33. The apparatus of claim 32, further comprising means for transmitting a revocation message to the mobile device to close the at least one additional PDN connection.

34. The apparatus of claim 33, wherein the revocation message is a binding revocation indication message of a PMIPv6 Proxy Binding Update message.

35. The apparatus of claim 28, wherein the means for associating the first PDN connection comprises means for receiving an address corresponding to the radio connection and associating the first PDN connection to the address.

36. The apparatus of claim 35, wherein the means for determining comprises means for determining whether a disparate address related to the at least one additional radio connection differs from the address corresponding to the radio connection.

37. The apparatus of claim 31, further comprising means for initializing a timer upon receiving the handover message.

38. The apparatus of claim 37, wherein the means for determining is enabled following expiration of the timer.

39. The apparatus of claim 27, wherein the first PDN connection relates to a 3GPP network and the at least one additional PDN connection relates to an IP network.

40. The apparatus of claim 28, wherein the means for determining is enabled based on at least one IP addresses or care of addresses (CoAs).

41. A computer program product comprising a computer-readable medium having codes for causing a computer to:
receive a message from a mobile device related to a first packet data network (PDN) connection to a first APN; and
associate the first PDN connection related to the mobile device with a radio connection between the mobile device and an access point in response to the message.

42. The computer program product of claim 41, further comprising codes to determine if the mobile device utilizes at least one additional radio connection with the access point to communicate over at least one additional PDN connection to the first APN.

43. The computer program product of claim 42, further comprising codes to revoke the at least one additional PDN connection based at least in part on determining that the mobile device utilizes the at least one additional radio connection, or to revoke the at least one additional PDN connection by transmitting a revocation message to the mobile device to close the at least one additional PDN connection.
